(19) United States
(12) Patent Application Publication
(10) Pub. No.: US 2013/0107243 A1
(43) Pub. Date: May 2, 2013

(54) Fast, High Resolution 3-D Flash LADAR Imager

(71) Applicants: David Ludwig, Irvine, CA (US); Medhat Azzazy, Laguna Niguel, CA (US)

(72) Inventors: David Ludwig, Irvine, CA (US); Medhat Azzazy, Laguna Niguel, CA (US)

(73) Assignee: Irvine Sensors Corporation, Costa Mesa, CA (US)

(21) Appl. No.: 13/099,829

(22) Filed: May 3, 2011

Related U.S. Application Data
(60) Provisional application No. 61/343,636, filed on May 3, 2010.

(51) Int. Cl. G01C 3/08; G06F 17/15

(52) U.S. Cl. CPC G01C 3/08; G06F 17/15
USPC 356/5.01; 702/189

(57) ABSTRACT

A device and method for LADAR ranging using relatively long laser pulse widths and slower system clock speeds is provided. The center points of the sent and received laser signal such as Gaussian laser pulses are identified by time sampling the sent and received laser signal waveforms at predetermined time positions.

The signal energy within each time sample of the respective sent and received laser signals defines a clock “bin”. The received laser signal generates an output from a photodetector cell on a focal plane array that is converted into voltage. The signal energy is integrated using a capacitor array for each of the clock bins and is representative of the signal energy in each time sample.

The output of the capacitor array is collected in buffer and digitized. Signal processing means extracts the center of the transmitted and received pulses and the time-of-flight calculated as the time between the transmitted and returned centers of the laser signal pulses.

### CROSS-REFERENCE TO RELATED APPLICATIONS

This application claims the benefit of U.S. Provisional Patent Application No. 61/343,636, filed on May 3, 2010 entitled “Fast, High Resolution 3-D Flash LADAR Imager” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention The invention relates generally to the field of electronic circuits and methods used in LADAR time-of-flight (“TOF”) ranging systems.

More specifically, the invention relates to a photodetector pixel and array read out method, circuit and module for use in an imaging device such as a LADAR imaging system. The device and method achieve high resolution in a LADAR ranging system while using relatively slower and lower cost system clock speeds. This permits the use of lower cost, longer pulse width lasers rather than higher cost, short pulse width lasers used in prior art time-of-flight LADAR systems.

2. Description of the Prior Art

Military applications have a need to combine multiple imaging technologies to detect, for instance, mines and obstacles in very shallow water (VSW), littoral zones, surf zones (SZ) and on the beach. It is desirable that such a detection system be sufficiently compact and lightweight to operate from a tactical unmanned aerial system or vehicle (“TUAV” herein) platform.

Three-dimensional flash LADAR technology is ideal for such TUAV detection applications. However, for three-dimensional flash LADAR systems to be effective in identifying mines and different obstacles in VSW, SZ and on the beach, the system requires a relatively high range resolution of just a few millimeters. The integration of a 3-D LADAR system on a TUAV coupled with the needed increase in pixel count and bandwidth to transmit the data, requires addressing prior art challenges in three major areas: (1) having a system range resolution of few millimeters while maintaining an acceptable signal-to-noise ratio, (2) providing a compact, lightweight, low power 3-D flash LADAR for the TUAV platform, and (3) ensuring sufficient on-board data storage and processing for the system to reduce bandwidth demands.

Irvine Sensors Corp., assignee of the instant application, has conducted work in the area of “Cognitive Processing” that has resulted in the development and demonstration of “human-like” sensor processing to detect and track features in complex scenes based on salient features of objects of interest in the scene.

Salient features may be defined in many dimensions, e.g., color, shape, orientation, texture, thermal state, polarization, and types or classes of motion including rotation, and zoom. Real time demonstrations of the “attention” or saliency search processing have been successfully conducted by Applicant. Recognition algorithms have been developed, validated in simulation, were the subject of several real-time demonstrations.

A purpose of cognitive processing is to provide the ability to process very large data volumes (many megapixels/sec) and to call attention to those areas or attributes which exhibit sufficient “saliency” as measured by operator priorities for target detection; in other words, “attention” processing. In cognitive processing, sensor modes are selected using a predetermined criterion or criteria for detailed examination of each of the detected “Regions of Interest” (ROIs) in the scene. Cognitive processing is intended to provide emulation of human visual system operations such as saccade and foveation, wherein the eye constantly scans a scene (saccade) and is moved to examine its ROIs with the higher resolution foveal area of the eye's retina (foveate).

In a multi-technique sensor suite that exploits this approach, the received sensor data is subject to “attention” processing and the resulting ROIs are then subject to very high resolution examination with the data undergoing “human-like” recognition processing. An important feature of cognitive processing is the fact large volumes of sensor data (for instance four mega-pixels) must be efficiently processed on board the TUAV; and preferably undergoes a significant reduction in data bandwidth requirements while increasing the timeliness of actionable data. A three-dimensional flash LADAR system capable of providing a few millimeters range of resolution comprising, for instance, a 1000×1000 pixel focal plane array, which, in one embodiment, may utilize cognitive image data processing, is disclosed.

The disclosed system is a time-of-flight system that takes advantage of correlation techniques to extract range data within a few millimeters while relaxing the demands on imaging laser temporal pulse width. This, in turn, results in a more compact laser transmitter and receiver suitable for, but not limited to, use with TUAV platforms.

Flash LADAR (laser detection and ranging) systems are used in commercial, military and scientific applications to provide three-dimensional imaging of an object of interest. Prior art LADAR generally systems rely on one of the three following techniques to measure the range of the surface of an object or target in a scene:

1 Coherent mixing,

2 Signal modulation techniques such as chirping,

3 Photon time-of-flight,

The coherent mixing LADAR technique depends on propagating a laser beam to the target (i.e., imaging or illuminating a scene of interest with the laser) and beating the return beam with the incident beam either inside or outside the laser cavity of the system. The resulting beat frequency can then be correlated with the range to the target using suitable electronic circuitry.

The range resolution in these forms of systems is typically limited to about 10 cm. The technique requires a coherent laser source which is very expensive. Additionally, the receiver in a coherent LADAR system must be capable of beating two very high frequencies which renders the receiver system very expensive and unsuitable for use in a TUAV.

Frequency modulation techniques involve amplitude or frequency modulation of the system's sent and received signals. The “chirp” technique may be regarded as a special case of frequency modulation. In the chirp technique, the range resolution is determined by ΔR=c/2ΔF where c is the speed of light and AF is the difference between the start and end frequencies of the chirp. Typical chirp frequencies are between 500 and 1000 MHz. The start (sent) and end (received) laser signal frequencies are selected to achieve the desired range resolution.

Typically, frequency modulation techniques can achieve about a 2-3 cm range resolution. Although prior art signal modulation techniques do not require laser coherence (which allows the use of relatively inexpensive laser diodes), the receiver system is complicated and requires the use of high frequency modulation in the GHz range and, again is not suitable for use in a TUAV.

The photon time-of-flight LADAR technique involves propagating or imaging a laser beam over a distance R(ange) to a target surface. The reflected/scattered laser signal from the target surface (sometimes referred to as “echo”) is collected by the LADAR system using a suitable photodetector such as a focal plane array (FPA). The FPA may be comprised of an array of photodetector pixel elements that are responsive to, and generate an electronic output as the result of, a predetermined range of the electromagnetic spectrum.

The time-of-flight for the reflected laser signal photons between the time they are emitted from the system laser to their return to the surface of photodetector array varies depending upon the distance of the target surfaces based upon the speed of light (c=3×10⁸ n/s) and the physical characteristics of the associated light conducting medium.

The range resolution in a time-of-flight LADAR system is thus determined both by the system clock speed and by the laser time pulse width. A prior art time-or-flight system clocking at 2 GHz can provide about 500 picoseconds of time history, which in turn, equates to about 7.5 cm of range resolution.

For either the coherent mixing technique or the time-of-flight technique, achieving acceptable resolution and lower minimum range requires the use of higher clock speeds. Unfortunately, current state-of-the-art clocks have a maximum speed of about 3-4 GHz resulting in about a 5-3.75 cm. range resolution respectively. These resolutions are only achieved when the laser pulse time width is very short, such as on the order of 1 nano-sec. As is known, these methods are very demanding on the laser side (higher laser output energy and shorter pulse width) and on the receiver side (higher clock speed) and undesirably increase weight, power and cost for TUAV applications.

### SUMMARY OF THE INVENTION

A device and method for LADAR ranging using relatively long laser pulse widths and slower system clock speeds is provided to overcome the deficiencies in the prior art.

The center points of the sent and received laser signal in the form of signal such as substantially Gaussian laser pulses in a time-of-flight system are identified by time sampling the sent and received laser signal waveforms at predetermined time positions.

The reflected and received laser signal generates an output from a photodetector cell on a focal plane array that is converted into a voltage. The signal energy within each time sample of the respective sent and received laser signals defines a clock “bin”. The signal energy of each of the clock bins for the respective sent and received laser signals is integrated using a capacitor array and is representative of the signal energy in each time sample.

The output of the capacitor array is collected in buffer and digitized using an analog-to-digital (ADC) converter circuit. Signal processing means is used to calculate the center of the transmitted and received pulses using a correlation or autocorrelation technique, curve-fitting or a convolution with the time-sample information. The time-of-flight calculated as the time between the transmitted and returned centers of the laser signal pulses.

In a first aspect of the invention, a method for determining the center point of a signal such as a substantially Gaussian temporal pulse of an electromagnetic signal is disclosed comprising the steps of time sampling the signal energy of an electromagnetic signal such as a substantially Gaussian temporal pulse of an electromagnetic signal at a predetermined number of time positions to define a predetermined number of clock bins, calculating the signal energy within each clock bin, and performing an autocorrelation function to interpolate between a predetermined number of clock bins to determine the center of the pulse.

In a second aspect of the invention, the signal energy calculation comprises an integration function.

In a third aspect of the invention a method for determining the center point of a substantially Gaussian temporal pulse of an electromagnetic signal is disclosed comprising the steps of time sampling the signal energy of a substantially Gaussian temporal pulse of an electromagnetic signal at a predetermined number of time positions to define a predetermined number of clock bins, calculating the signal energy within each clock bin, and performing a curve fitting function to interpolate between a predetermined number of clock bins to determine the center of the pulse. The third aspect may comprise an integration function.

In a fourth aspect of the invention the curve-fitting function comprises an erf function.

In a fifth aspect of the invention, a method for determining the range of a target surface is disclosed comprising the steps of imaging a target surface with a first electromagnet signal having a substantially Gaussian pulse temporal distribution, receiving a second reflected electromagnetic signal having a substantially Gaussian pulse temporal distribution from the target surface, time sampling the signal energy of the first and second electromagnetic signals at a predetermined number of time positions to define a predetermined number of clock bins for each of the first and second electromagnetic signals, calculating the signal energy within each clock bin, performing an autocorrelation to interpolate between a predetermined number of clock bins of the first electromagnetic signal and performing an autocorrelation to interpolate between a predetermined number of clock bins of the second electromagnetic signal to determine the center of the first and second electromagnetic pulses, and determining the time difference between the centers of the first and second electromagnetic signals.

In a sixth aspect of the invention, a method for determining the range of a target surface is disclosed comprising the steps of imaging a target surface with a first electromagnet signal having a substantially Gaussian pulse temporal distribution, receiving a second reflected electromagnetic signal having a substantially Gaussian pulse temporal distribution from the target surface, time sampling the signal energy of the first and second electromagnetic signals at a predetermined number of time positions to define a predetermined number of clock bins for each of the first and second electromagnetic signals, calculating the signal energy within each clock bin, performing a curve fitting function to interpolate between a predetermined number of clock bins of the first electromagnetic signal and performing a curve fitting function to interpolate between a predetermined number of clock bins of the second electromagnetic signal to determine the center of the first and second electromagnetic pulses, and determining the time difference between the centers of the first and second electromagnetic signals.

In a seventh aspect of the invention, a method for determining the range of a target surface is disclosed comprising the steps of imaging a target surface with a first electromagnet signal having a substantially Gaussian pulse temporal distribution, receiving a second reflected electromagnetic signal having a substantially Gaussian pulse temporal distribution from the target surface, time sampling the signal energy of the second electromagnetic signal at a predetermined number of time positions to define a predetermined number of clock bins for second electromagnetic signal, calculating the signal energy within each clock bin, providing a weighting factor based an expected second electromagnetic signal, performing a convolution on the second electromagnetic signal using the weighting factor to determine its center, and determining the time difference between the centers of the first and second electromagnetic signals which aspect may comprise an integration function.

These and other aspects of the invention are more fully discussed below.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE DRAWINGS

FIGS. 1A, 1B and 1C respectively, show an integrated circuit chip having at least one circuit of the invention disposed thereon, a stack of the integrated circuit chips and a stack of the integrated circuit chips with a photodetector array to be bump-bonded on the surface of the stack of chips.

FIG. 2 illustrates a laser pulse and return signal in a prior art laser time-of-flight ranging LADAR system.

FIG. 3 depicts a laser pulse having a Gaussian pulse temporal energy distribution in a LADAR system of the invention, illustrating the bin interpolation of the center of the pulse.

FIG. 4 depicts the available energy for each time sample point in the Gaussian pulse of FIG. 3.

FIG. 5 is a block diagram of a preferred circuit of a time-of-flight correlation ranging readout integrated circuit of the invention.

FIG. 6 sets forth a set of specifications of a preferred embodiment of a time-of-flight correlation ranging system of the invention.

FIG. 7 is a simplified illustration of a laser scanning over a focal plane array.

FIG. 8 is a graph illustrating the signal-to-noise ratio vs. range of a preferred embodiment of the system of the invention using time-of-flight correlation and illustrating coverage of a 17×17 degree field of view once per second with a 3 mm range resolution and a pixel footprint of 15×15 mm at a 100 meter range.

FIG. 9 is a schematic block diagram of an alternative preferred embodiment of the circuit of the invention.

FIGS. 10a-f illustrate various waveform attributes using an erf method of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Prior art photodetector sensor read out integrated circuits (or “ROICs”) used in existing LADAR imaging circuitry are constrained in functionality due to small unit cell size, power demands, speed and complexity. Fortunately, high density microelectronic integrated circuit (“IC”) chip stacking technology such as by Irvine Sensors Corp., assignee herein, provides ROIC design options with enhanced flexibility by offering greatly increased ROIC circuit element density than is provided in prior art, non-stacked design solutions.

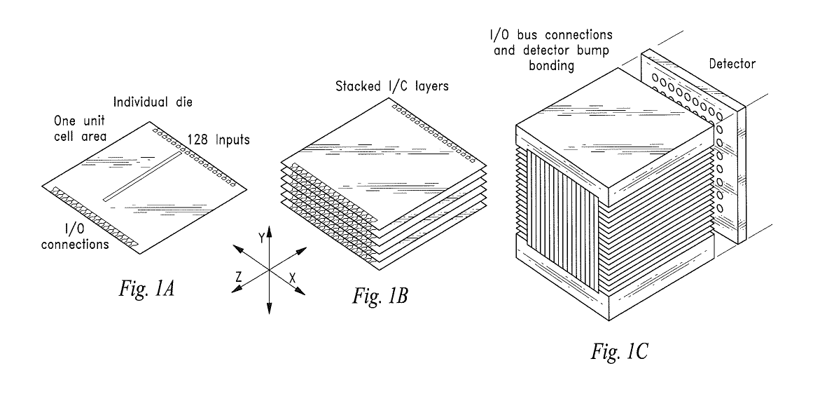

An exemplar LADAR imaging module architecture incorporating the stacked IC chip technology referred to above is shown in FIGS. 1A, 1B and 1C and is disclosed in, for instance, U.S. Pat. No. 7,436,494 entitled “Three-Dimensional LADAR Module With Alignment Reference Insert Circuitry” to Kennedy et al. and issued on Oct. 14, 2008.

FIG. 1a shows an IC layer having a unit cell with a circuit of the invention fabricated thereon and having I/O connections and detector inputs that define edge electrical connection points when the layers are stacked.

FIG. 1B shows a plurality of layers whereby the respective I/O connections and detector inputs are in vertical alignment.

FIG. 1C shows a bonded stack of IC layers and a photodetector element to be electrically connected to the detectors inputs using the edge connection points of the layers in the stack. The I/O connections may be interconnected or connected to external control circuitry using metalized “T-connect” structures defined by photolithography and plating methods.

In the illustrated representative stacked architecture, each IC in the stack of ICs contains the photodetector output signal unit cells for one row in the sensor's detector array of pixels.

The number of pixel columns in the sensor's detector array determine the desired number of ICs in the stack.

The photodetector array may be conventionally bump-bonded (such as indium bump-bonding) after the IC stacking process is completed. Individual IC layers in the stack are designed with at least the number of unit cell channels desired to readout a single row of pixels in the detector array. The unit cell spacing is based upon the detector pixel pitch in the X-axis but can be arbitrarily long in the Z-axis. The final size of the completed photodetector imaging module of the invention is based on several stacking processing factors, but can be quite small.

The invention described herein is directed toward a LADAR read out circuit and ranging method and permits the use of a lower-cost laser with a pulse width of about one order of magnitude longer than existing time-of-flight lasers. The circuit of the invention further permits the use of slower system clock speeds on the order of about one magnitude slower than prior art time-of-flight system clock speeds while achieving range resolutions about one order of magnitude finer than prior art LADAR techniques.

The preferred embodiment of invention herein is referred to as “time-of-flight correlation ranging” (“TFCR”)” and provides both spatial and ranging resolutions as fine as a few millimeters at kilometer-range distances using a combination of a novel ROIC design (read-out integrated circuit) and a mathematical correlation and signal processing technique to interpolate within the time-of-flight measurements to determine the target range with a high degree of resolution.

Turning now to FIG. 2, a laser sent and returned signal of a prior art LADAR system requires are depicted, showing that the laser pulse of a prior art system has a very short rise time and a relatively narrow temporal distribution.

As is known, prior art time-of-flight LADAR systems comprise a timing circuit functioning as a “stop watch” that is triggered at a T₀ when the laser transmitted pulse crosses a first predetermined threshold level. The time-of-flight of the transmitted laser pulse is measured when the return signal crosses a predetermined second threshold level of FIG. 2. The range is determined from the time-of-flight between the transmitted and returned beams or signals. The range resolution of the system thus depends on the clock speed, laser temporal pulse characteristics and threshold levels.

For prior art time-of-flight LADAR systems, a clock speed of about 15 GHz would be required in order to get about a one centimeter range resolution. This equates to about one order of magnitude higher than state-of-the-art technology currently provides. Moreover, such laser temporal pulse characteristics (rise time and width) are very restrictive, resulting in lower system efficiency and reliability and in higher cost.

The disclosed time-of-flight correlation ranging invention (TFCR) addresses these and other deficiencies in the prior art and beneficially permits the use of relatively slow system clocks ˜500 MHz (2 nano-sec) clock with lower cost lasers having longer pulse widths.

In a preferred embodiment of the invention, a predetermined number of pulse time samples or slices N of an electromagnetic signal such as the temporal transmitted and returned Gaussian pulse of a LADAR are measured and the energy within each pulse time sample calculated.

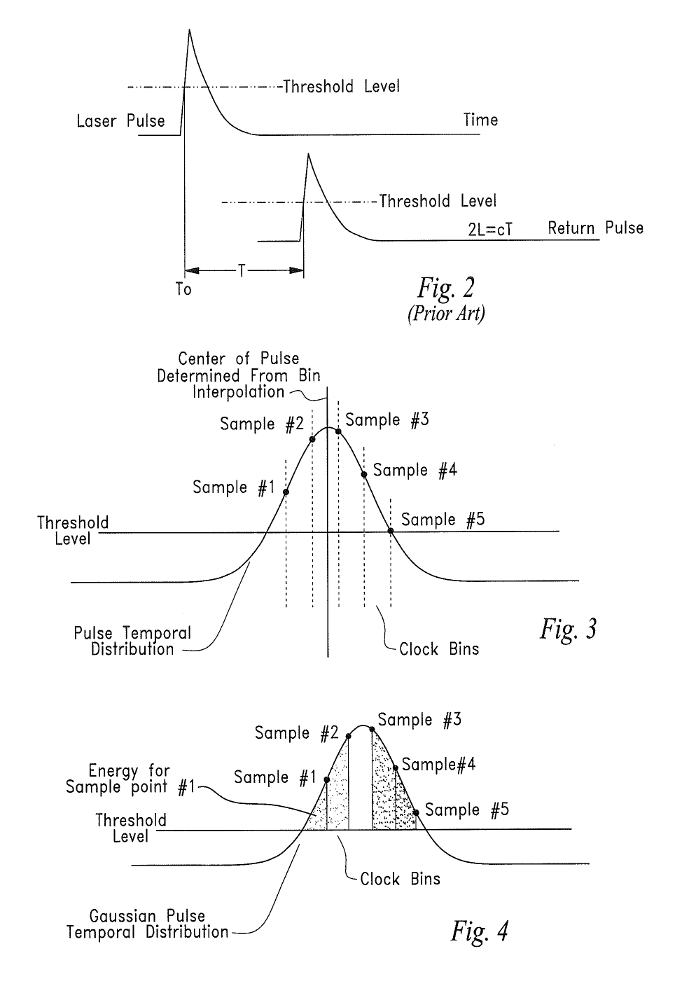

In the exemplar laser signal pulse of FIG. 3, the invention measures five points of the temporal transmitted and returned pulse width having a Gaussian temporal energy distribution. It is noted that the example of FIG. 3 measures five points in the signal but any desired number of time sample points to provide N number of time samples may be used. The signal need not be Gaussian in distribution and may comprise a signal of any distribution where curve-fitting, autocorrelation or a convolution may be applied.

Either curve-fitting or autocorrelation processing means may be used to interpolate between the pulse time samples to determine the center of the pulse. The time-of-flight of the pulse is then calculated using suitable electronic circuitry as the time between the transmitted and returned centers of the pulse.

In the illustrated example of FIGS. 3 and 4, the five pulse time sample points may be selected to be above a predetermined threshold level that may be determined by the signal-to-noise ratio. In the illustrated example, for a signal-to-noise ratio of about 20 db (SNR 10:1), autocorrelation between the transmitted laser temporal pulse width and the received temporal pulse width will determine the signal time-of-flight with a resolution of better than 100 times the clock resolution. Therefore a 500 MHz clock and autocorrelation can provide about a 3 mm. range resolution though any of a predetermined number of time samples N of the transmitter and receiver temporal pulse widths may be used.

For the simple Gaussian temporal pulse width and the illustrated five point time sample measurement of FIGS. 3 and 4, the laser energy per time sample defines a clock bin and varies temporally over the Gaussian pulse. In the illustrated example, the minimum laser energy per time sample is about 8.5% of the total laser energy for the pulse, assuming the threshold level is set at about 50% of the maximum. This minimum energy per bin may be increased or decreased to a predetermined threshold by the user merely by incorporating a lower or higher signal threshold level.

The reduction in laser energy per time sample or slice may be countered by relaxing the design requirement that the laser temporal pulse width be very narrow; i.e., comparable to the clock time step. This can result in the reduction of the output laser energy per pulse by a factor of about 10. In addition, relaxing the requirement on the laser temporal pulse width permits the use of less complicated laser systems and therefore provides more reliable and cost-effective systems.

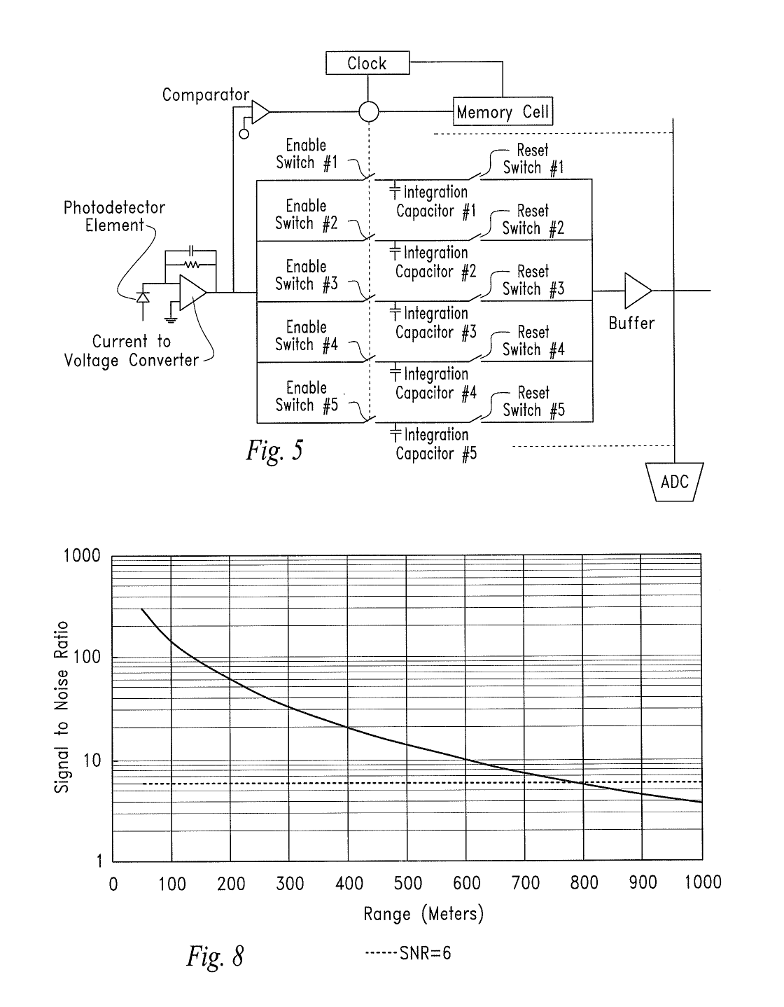

A schematic diagram for a preferred embodiment the read-out integrated circuit of the invention is shown in FIG. 5.

The output from each cell in the focal plane array is converted to voltage and then passes through the circuit. The signal energy is integrated for each of the clock bins using a capacitor in the capacitor bank array. In the embodiment, five switches are used to turn-on the capacitors and five switches are used for reset.

The comparator of the system allows the signal to build above the threshold level. The clock is running all the time and the signal from the clock is stored in a memory cell. Once the signal is higher than the predetermined threshold level, the clock switch turns on and the capacitor assigned to the time sample period switches according to the clock time bins. The output of the individual capacitors are then individually collected in a buffer and digitized. The signal processor is then used to extract the center of the transmitted and received pulses and hence the interpolated time of flight.

A preferred embodiment baseline LADAR time-of-flight correlation ranging (TFCR) system comprises a frequency-doubled Nd-YAG (about 532 nm) laser operating in the green region of the electromagnetic spectrum. The preferred focal plane array is a CMOS 1000×1000 pixel imager.

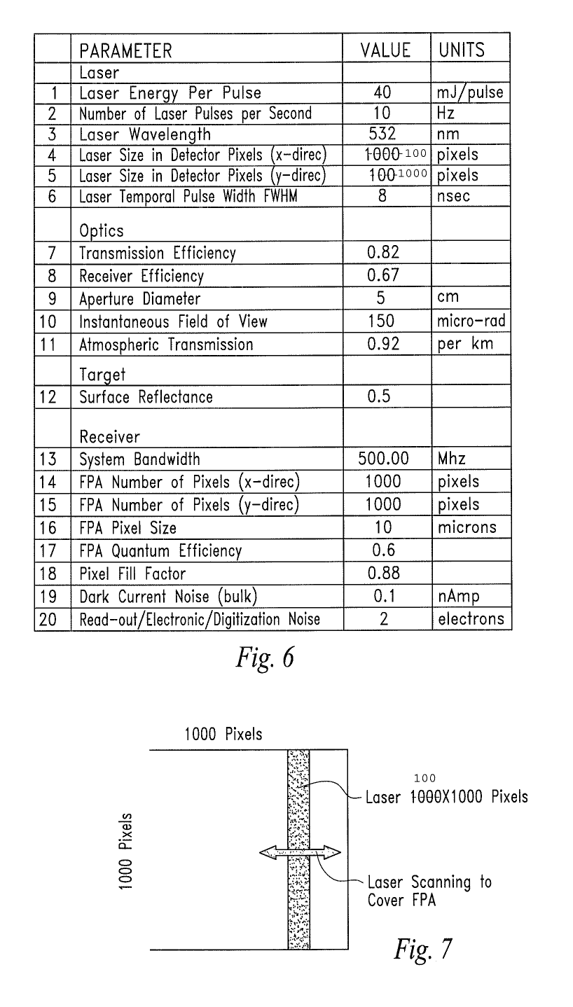

A baseline system set of operational specification of a preferred embodiment of the LADAR time-of-flight correlation ranging (TFCR) system of the invention is given in FIG. 6.

In the exemplar baseline system, the laser output (typically round beam) may be shaped to a rectangle to fit the focal plane array geometry using suitable beam-forming digital optics. The optical throughput of these elements is typically about 92% to 95%.

As see in FIG. 7, due to laser output energy characteristics and the number of detector pixels that the laser should cover, the baseline system may have a laser output that fits the 1000×100 detector pixels of the specified CMOS imager. The laser output is then scanned to cover the 1000×1000 detector pixels. Therefore, the baseline system covers a field of view of 18×18 degrees every second.

FIG. 8 is a graph illustrating the signal-to-noise ratio vs. range of a preferred embodiment of the system of the invention using time-of-flight correlation and illustrating coverage of a 17×17 degree field of view once per second with a 3 mm range resolution and a pixel footprint of 15×15 mm at a 100 meter range.

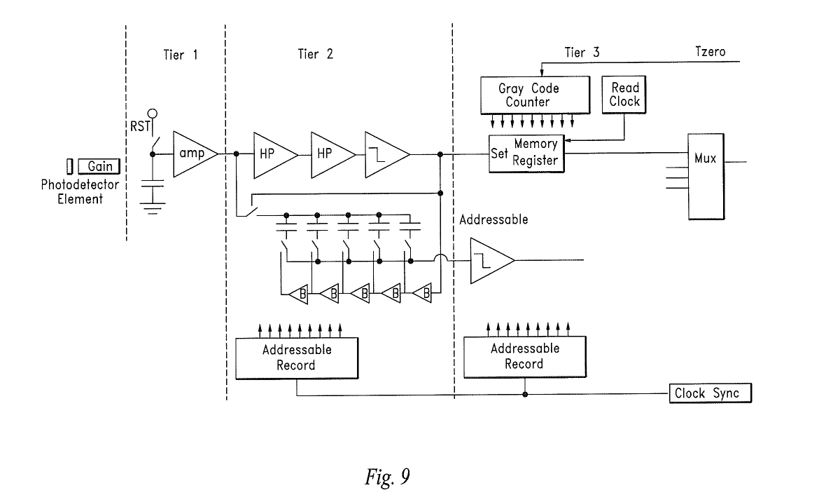

In an alternative embodiment of the invention a waveform sampling for very fine range resolution in a LADAR time-of-flight system is depicted in FIG. 9.

It is possible to obtain improved and finer range resolution than the sampling clock speed if the wave-shape of the return echo is known. In such a case, curve-fitting or autocorrelation may be applied “off board” or external of the focal plane array circuitry to obtain a factor improvement that is dependent in part on the signal-to-noise ratio and on the quality of the return echo compared to the expected return signal.

This embodiment of the invention is well-suited for longer pulse lasers in that it results in good range resolution in a low frequency LADAR system but also yields good results and fine range resolution when used in high frequency LADAR systems that incorporate short pulse lasers.

In a preferred embodiment of the invention shown in FIG. 9, a block diagram schematic of a “unit cell” that samples both the comparator state and the analog wave form is illustrated. The comparator and latch of FIG. 9 provide a record of what count at which the echo signal was detected.

The capacitor bank (integration capacitors #1-5 in cooperation with enable and reset switches and buffer circuits #1-5) captures the Gaussian pulse waveform that, in turn, is used to determine where inside the gray code numeric value the return pulse was captured.

The preferred embodiment for capturing the waveform inside the unit cell is via the array of capacitors in the capacitor bank which may vary in number depending on the number of time samples a user which wishes to sample (e.g., three time samples would incorporate a capacitor bank of three capacitors).

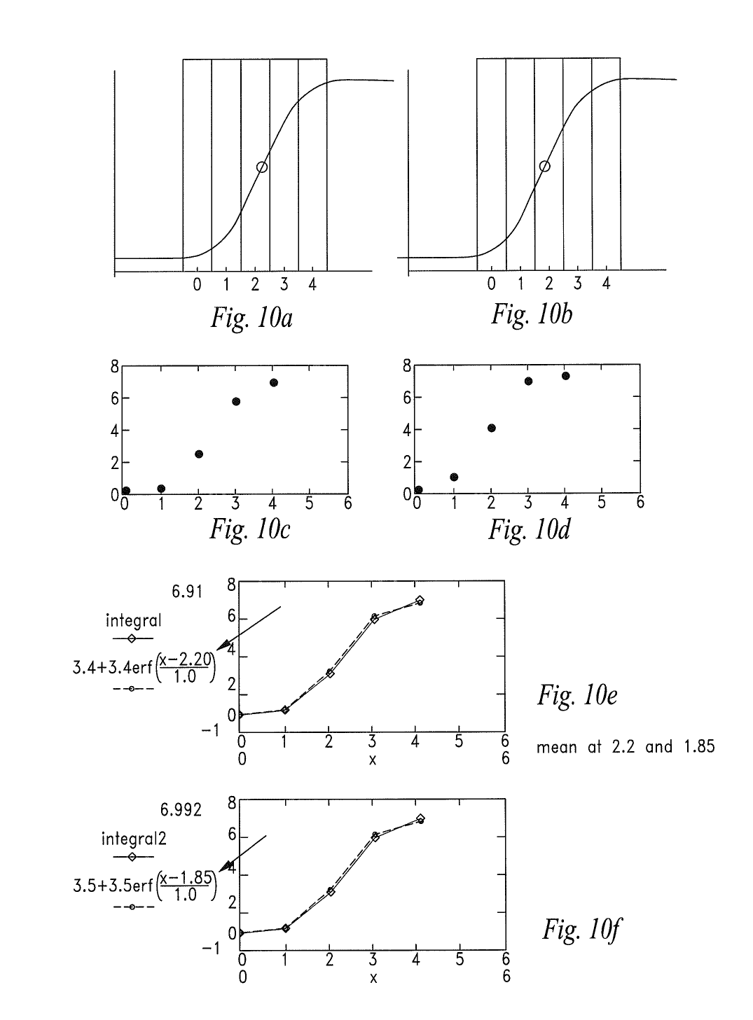

In operation, the capacitors in the capacitor bank array are turned on sequentially using a system clock, such that each one integration capacitor captures the signal from an integrated Gaussian. Attributes and calculations related to the captured or received signal are depicted as shown in FIGS. 10a-f. Two signals are shown, one from an echo that occurs early in a sample period and one that occurs later.

FIG. 10a illustrates an echo waveform with two midpoints at the end and beginning of a sampling period.

FIG. 10b shows values captured in the capacitor bank at each sampling period.

FIGS. 10c and 10d depict curve fitting using an erf function (i.e., error function, Gauss error function or probability integral). The mean indicates when the center of the waveform falls within the sampling period.

These data points are used to curve fit the return signal using the erf function. The mean of the erf function curve fit, highlighted with the arrow in FIGS. 10e and 10f indicates the time at which the center of the echo is captured. In high signal-to-noise cases, the improvement in range resolution over the sample rate can be greater than 10 using this embodiment.

This alternative embodiment utilizes a similar technique that requires waveform capturing but instead of curve fitting the return waveform, the circuit effectively performs a convolution on the received pulse.

The return pulse is used as a weighting factor and the captured signal is convolved with the weight weighting factor. The point during the convolution where the signal peaks, i.e. the point where the correlation is the highest, represents the position of the signal in time. The position is accurate if the convolution increments are finer than the ROIC sampling rate.

This embodiment has benefits over the curve-fitting method when signal-to-noise ratio is low and both approaches have improved resolution with an increase in the numbers of capacitors for sampling inside the ROIC to give a better representation of what the echo waveform looks like.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A method for determining the center point of a pulse of an electromagnetic signal comprising the steps of:
time sampling the signal energy of a pulse of an electromagnetic signal at a predetermined number of time positions to define a predetermined number of clock bins,
calculating the signal energy within each clock bin, and,
performing an autocorrelation function to interpolate between a predetermined number of clock bins to determine the center of the pulse.

2. The method of claim 1 wherein the signal energy calculation comprises an integration function.

3. A method for determining the center point of a pulse of an electromagnetic signal comprising the steps of:
time sampling the signal energy of a pulse of an electromagnetic signal at a predetermined number of time positions to define a predetermined number of clock bins,
calculating the signal energy within each clock bin, and,
performing a curve fitting function to interpolate between a predetermined number of clock bins to determine the center of the pulse.

4. The method of claim 3 wherein the signal energy calculation comprises an integration function.

5. The method of claim 3 where the curve-fitting function comprises an erf function.

6. A method for determining the range of a target surface comprising the steps of:
imaging a target surface with a first electromagnet signal having a substantially Gaussian pulse temporal distribution,
receiving a second reflected electromagnetic signal having a substantially Gaussian pulse temporal distribution from the target surface,
time sampling the signal energy of the first and second electromagnetic signals at a predetermined number of time positions to define a predetermined number of clock bins for each of the first and second electromagnetic signals,
calculating the signal energy within each clock bin,
performing an autocorrelation to interpolate between a predetermined number of clock bins of the first electromagnetic signal and performing an autocorrelation to interpolate between a predetermined number of clock bins of the second electromagnetic signal to determine the center of the first and second electromagnetic pulses, and,
determining the time difference between the centers of the first and second electromagnetic signals.

7. The method of claim 6 wherein the signal energy calculation comprises an integration function.

8. A method for determining the range of a target surface comprising the steps of:
imaging a target surface with a first electromagnet signal having a substantially Gaussian pulse temporal distribution,
receiving a second reflected electromagnetic signal having a substantially Gaussian pulse temporal distribution from the target surface,
time sampling the signal energy of the first and second electromagnetic signals at a predetermined number of time positions to define a predetermined number of clock bins for each of the first and second electromagnetic signals,
calculating the signal energy within each clock bin,
performing a curve fitting function to interpolate between a predetermined number of clock bins of the first electromagnetic signal and performing a curve fitting function to interpolate between a predetermined number of clock bins of the second electromagnetic signal to determine the center of the first and second electromagnetic pulses, and,
determining the time difference between the centers of the first and second electromagnetic signals.

9. The method of claim 8 wherein the signal energy calculation comprises an integration function

10. A method for determining the range of a target surface comprising the steps of:
imaging a target surface with a first electromagnet signal having a substantially Gaussian pulse temporal distribution,
receiving a second reflected electromagnetic signal having a substantially Gaussian pulse temporal distribution from the target surface,
time sampling the signal energy of the second electromagnetic signal at a predetermined number of time positions to define a predetermined number of clock bins for second electromagnetic signal,
calculating the signal energy within each clock bin,
providing a weighting factor based an expected second electromagnetic signal,
performing a convolution on the second electromagnetic signal using the weighting factor to determine its center, and,
determining the time difference between the centers of the first and second electromagnetic signals.

11. The method of claim 10 wherein the signal energy calculation comprises an integration function
